(19) United States
(12) Patent Application Publication
(10) Pub. No.: US 2024/0416565 A1
(43) Pub. Date: Dec. 19, 2024

(54) AN INJECTION APPARATUS FOR PRODUCING HOLLOW PLASTIC ARTICLES, IN PARTICULAR BOTTLE PREFORMS

(71) Applicant: S.I.P.A. Società di Industrializzazione Progettazione e Automazione S.P.A., Vittorio Veneto (IT)

(72) Inventors: Elvis MENEGOL, Limana (IT); Nicola STELLA, Farra Di Soligo (IT); Matteo ZOPPAS, Conegliano (IT)

(21) Appl. No.: 18/698,030

(22) PCT Filed: Oct. 3, 2022
(86) PCT No.: PCT/IB2022/059405

§ 371 Date: Apr. 3, 2024

(30) Foreign Application Priority Data
Oct. 4, 2021 (IT) 102021000025337

(51) Int. Cl. B29C 45/13; B29C 45/18; B29C 45/23; B29K 67/00; B29L 31/00

(52) U.S. Cl. CPC B29C 45/13; B29C 45/1866; B29C 45/23; B29K 2067/003; B29L 2031/7158

(57) ABSTRACT

An injection apparatus (100) for injecting molten plastic into a mold for molding one or more hollow articles, in particular, bottle preforms; the injection apparatus (100) comprising—two injectors (1, 2), each defining a respective longitudinal axis (X, X′), adapted to receive the molten plastic and inject it alternately into the mold; —and a conduit (3, 31, 32, 33), having an inlet opening (30) for the molten plastic, adapted to be connected to a plasticization apparatus (102) and to conduct the molten plastic from the plasticization apparatus (102) towards the two injectors (1, 2); wherein the length of said conduit (3) is less than the length (Ltot) of each of the two injectors (1, 2) along the respective longitudinal axis (X, X′).

### FIELD OF THE INVENTION

The present invention relates to the field of molding hollow plastic articles, such as, for example, bottle preforms.

In particular, the invention regards an injection apparatus, which is particularly adapted to inject molten plastic coming from a plasticizing apparatus, which can generate a substantially continuous flow of molten plastic. The molten plastic can be produced starting from plastic, such as, for example, PET, in the form of flakes.

### BACKGROUND ART

In order to produce bottle preforms, an apparatus is usually used comprising an extruder and only one injector.

The advancing and retreating movements of the screw of the extruder and of the piston of the injector are asynchronous.

In fact, while the screw rotates and retreats along the longitudinal axis thereof while melting the granules, typically of PET, and accumulating the volume of molten plastic needed for the successive injection (plasticization step), the piston advances to inject the molten plastic into the mold (injection step); and vice versa while the screw rotates and advances along the longitudinal axis thereof, to transfer the molten plastic produced in the plasticization step (transfer step), the piston retreats so that the injector fills with molten plastic (loading step).

Thus, the flow of molten plastic produced by the extruder is discontinuous.

This is the standard process carried out when the raw material, which must be melted by the extruder is in the form of pellets or granules, in particular, when the raw material is virgin PET, or, in the case of recycled and recast material, rPET.

It is increasingly requested the use of material in the form of flakes, obtained from the grinding of preforms and bottles, without melting them.

In order to produce preforms starting from PET in flakes, a plasticization apparatus is required, comprising the extruder, which is designed to operate differently to the one described previously.

Unlike PET in pellets, PET in flakes, due to the smaller apparent density thereof, can require a particular plasticization process, where the screw does not advance/retreat in accordance with the previous description, but operates in a manner referred to as pure extruding. Basically, the screw rotates at a constant speed without advancing/retreating along the longitudinal axis thereof.

This results in a flow of molten plastic, exiting the plasticization apparatus, which is substantially continuous and constant, and no longer discontinuous as in the process described previously.

Thus, as the flow exiting the extruder is continuous, two injectors are needed.

In particular, downstream of the extruder, two injectors alternatively receive the molten plastic from the extruder. More specifically, the apparatus is designed so that while a first injector is injecting the molten plastic into the mold, a second injector receives the molten plastic from the extruder, and vice versa.

A critical aspect of this process is the degradation of the molten plastic. In particular, the degradation of PET leads to the formation of undesired volatile compounds, such as acetaldehyde and benzene.

Managing to avoid the degradation of molten plastic is not trivial, especially when performing a preform production process starting from PET in the form of flakes.

At present, with apparatuses for producing preforms starting from PET in the form of flakes, it is impossible to avoid or in any case satisfactorily minimize the degradation of molten PET.

Therefore, the need is felt for an apparatus, in particular, for producing bottle preforms starting from PET in the form of flakes, which allows reducing the degradation of molten PET.

### SUMMARY OF THE INVENTION

It is an object of the present invention to make an injection apparatus for producing hollow articles, e.g., bottle preforms, in particular starting from plastic in the form of flakes to be melted, which allows reducing the degradation of the molten plastic, in particular of the molten PET.

The present invention achieves at least such object, and other objects, which will be apparent in light of the present description, by means of an injection apparatus for injecting molten plastic into a mold, in particular, for molding one or more hollow articles, in particular bottle preforms;
the injection apparatus comprising
   two injectors, each defining a respective longitudinal axis, adapted to receive the molten plastic and inject it alternately into the mold;
   and a conduit (or tubing or conduit system), having an inlet opening for the molten plastic, adapted to be connected to a plasticization apparatus and to conduct the molten plastic from the plasticization apparatus towards the two injectors or to the two injectors;
wherein the length of said conduit is smaller than the length of each of the two injectors along the respective longitudinal axis.

The invention also relates to a molding apparatus, in particular according to claim 20.

Advantageously, an injection apparatus according to the invention allows avoiding or minimizing the degradation of molten plastic, in particular, of molten PET.

To this end, the length of the aforesaid conduit has been carefully selected.

Further features have been identified in order to further optimize the minimization of the degradation of the molten plastic.

The inventors have found that the length of the conduit which conducts the molten plastic from the plasticization apparatus to the injectors significantly impacts the degradation of the molten plastic.

In particular, the inventors have found that a conduit which is too long, increases the stay time of the plastic melted at a high temperature, leading to a degradation of the molten plastic.

Whereas, by selecting the length of the conduit so that it is smaller than the length of each of the injectors, it is possible to reduce the stay time of the plastic melted at a high temperature and thus minimize the degradation of the molten plastic.

Preferably, in all embodiments, the aforesaid conduit is the only conduit adapted to conduct the molten plastic from the plasticization apparatus towards the two injectors or to the two injectors; i.e., other conduits are not provided for such object.

Further features and advantages of the invention will become more apparent in the light of the detailed description of exemplary, but non-exclusive embodiments.

The dependent claims describe particular embodiments of the invention.

### BRIEF DESCRIPTION OF THE FIGURES

In the description of the invention, reference is made to the accompanying drawings, which are provided by way of non-limiting example, in which:

FIG. 1 shows a perspective view of an injection apparatus according to the invention;

FIG. 2 shows a side view of the injection apparatus according to FIG. 1;

FIG. 3 shows a side view of some components of the injection apparatus in FIG. 1;

FIG. 4 shows a view from above of the components in FIG. 3;

FIG. 5 shows section A-A of FIG. 4;

FIG. 6 shows a perspective view of a section on two planes transversal to each other of part of the components in FIG. 3;

FIG. 7 shows a perspective view of a section of FIG. 6;

FIG. 8 shows a side view of part of the components in FIG. 3;

FIG. 9 shows section B-B of FIG. 8;

FIG. 10 shows a side view of a molding apparatus according to the invention, where the plasticization apparatus is shown diagrammatically.

The same elements or components have the same reference numeral.

### DESCRIPTION OF EXEMPLARY EMBODIMENTS OF THE INVENTION

With reference to the Figures, exemplary embodiments of an injection apparatus 100, or injection machine, according to the invention are described.

In particular, the injection apparatus 100 is for molding hollow articles, in particular preforms, more particularly bottle preforms.

In fact, the injection apparatus 100 is adapted to inject molten plastic into a mold (not shown) of one or more hollow articles, such as bottle preforms. The mold can be, for example, provided with a plurality of molding cavities, each for a respective hollow article, e.g., each for a respective preform.

The injection apparatus 100 is suitable for injecting the molten plastic (or molten polymer) produced by the plasticization of polymer material, e.g., PET (Polyethylene terephthalate), in particular in the form of flakes.

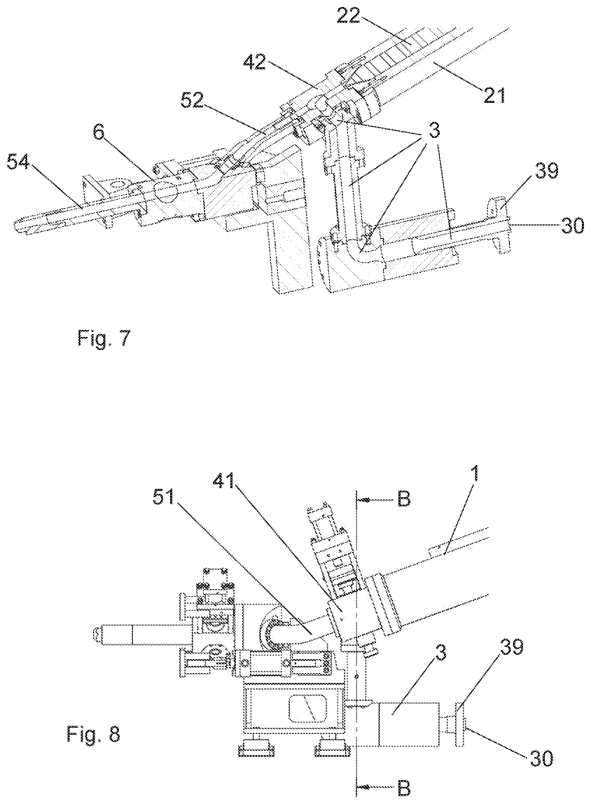

In all the embodiments, the injection apparatus 100 comprises
two injectors 1, 2, each defining a respective longitudinal axis X, X′, adapted to receive the molten plastic and inject it into the mold (i.e., into the same mold) alternately, in particular, alternately between each other; in particular, the injectors 1, 2 are connected to a tubing 5 (FIG. 6), or conduit or conduit system, which serves to conduct the molten plastic injected by the injectors 1, 2 towards the mold, in particular, towards the same mold;
and a conduit 3, or tubing or conduit system, having an inlet opening 30 (FIG. 7, 8) for the molten plastic, adapted to be connected to a plasticization apparatus 102 and to conduct the molten plastic from the plasticization apparatus 102 towards the two injectors 1, 2, or possibly to the two injectors 1, 2;
wherein the length of said conduit 3 is less than the length Ltot, in particular than the total length, of each of the two injectors 1, 2 along the respective longitudinal axis X, X′.

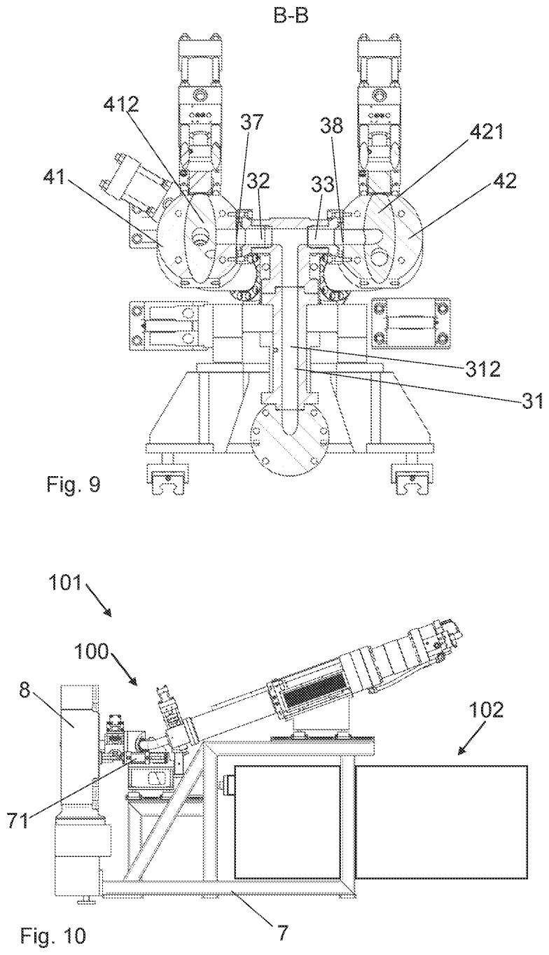

The conduit 3 preferably has two outlet openings 37, 38 (FIG. 9), which are distinct from each other and distinct from the inlet opening 30. In particular, the conduit 3 preferably has only one inlet opening 30 and only two outlet openings 37, 38.

In particular, the conduit 3 is adapted to conduct the molten plastic from the plasticization apparatus 102 into the two injectors 1, 2.

In particular, the “length” of the conduit 3 is understood to mean the length of the path which the molten plastic covers when it crosses the conduit 3 from the start to the end thereof, in particular from the inlet opening 30 to the two outlet openings 37, 38.

In particular, the inlet opening 30 is adapted to be connected to the plasticization apparatus 102.

An end portion 39 of the conduit 3 is provided with said inlet opening 30.

The conduit 3 can comprise, for example, curved stretches and/or mutually inclined stretches, and/or a branching, in particular a bifurcation.

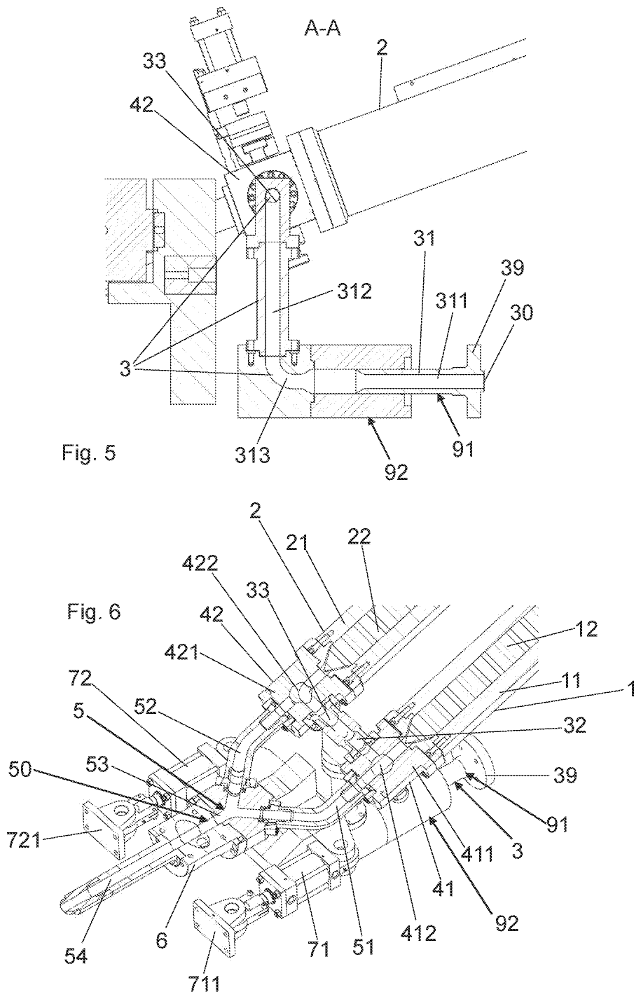

In particular, the conduit 3 comprises, preferably consists of, a first stretch 31 (FIG. 5, 6, 9), provided with said inlet opening 30; and two branches 32, 33, each branch 32, 33 being adapted to conduct the molten plastic towards a respective injector 1, 2. Each branch 32, 33 is provided with a respective outlet opening 37, 38 of the conduit 3.

The length of the conduit 3 comprises the length of the first stretch 31, and the length of each of the two branches 32, 33; in particular, the length of the conduit 3 is preferably equal to the sum of the length of the first stretch 31, and of the length of each of the two branches 32, 33.

The aforesaid first stretch 31, preferably comprises a stretch 311, which is substantially horizontal, or in any case parallel to the support plane of the injection apparatus 100.

Stretch 311 preferably has the aforesaid inlet opening 30.

The aforesaid first stretch 31, preferably comprises two stretches 311, 312 (or sub-stretches or portions), which are transversal to each other, e.g., orthogonal to each other. The first stretch 31 can have, for example, a substantially L shape. The two stretches 311, 312 are joined to each other by a connection stretch 313. In particular, the connection stretch 313 is substantially an elbow.

Part of the conduit 3 is preferably delimited by a component, for example, a T-shaped- or a Y-shaped tube, which comprises said two branches 32, 33. In particular, said T- or Y-shaped component also comprises part of the first stretch 31 of conduit 3, in particular, part of stretch 312.

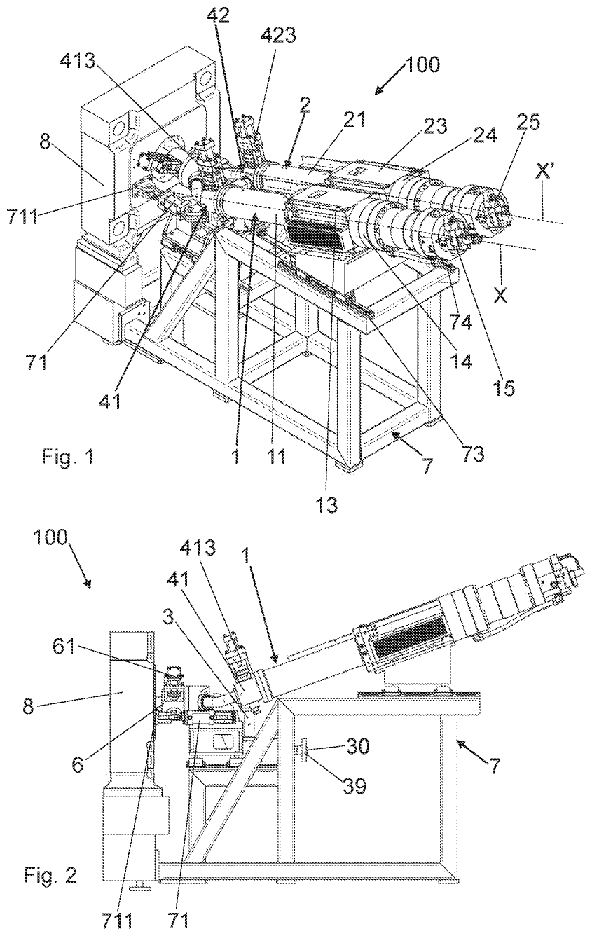

Each of the injectors 1, 2 comprises a body 11, 21 (FIG. 1, 3) adapted to receive the molten plastic, a piston 12, 22 adapted to slide in the body 11, 21, and actuation means 14, 24 adapted to move the piston 12, 22. In particular, the body 11, 21, the piston 12, 22 and the actuation means 14, 24 are crossed by the same longitudinal axis X, X′.

Each injector 1, 2, in particular the respective body 11, 21, is provided with a respective opening through which the molten plastic can pass for entering and exiting the injector 1, 2.

The molten plastic is received in the space delimited, in particular, by the body 11, 21 and by the piston 12, 22 of each injector 1, 2.

Said length Ltot of each injector 1, 2 comprises the length Lcm of said body 11, 21 and the length Lhc of said actuation means 14, 24 (also the length Lhc is measured along the longitudinal axis X, X′). The actuation means 14, 24 preferably comprise, or consist of, an actuation cylinder, preferably a hydraulic cylinder.

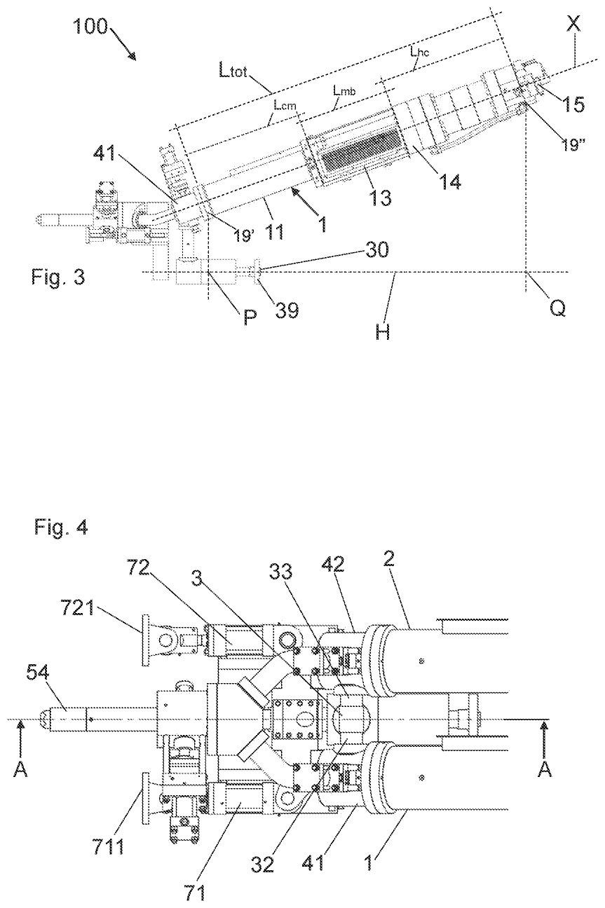

In particular, each injector 1, 2 has a first axial end 19′ (FIG. 3) and a second axial end 19″. The first axial end 19′ delimits the opening of said body 11, 21 through which the molten plastic can pass, in particular for entering and exiting the body 11, 21. The second axial end 19″ is preferably one end of said actuation means 14, 24, in particular the distal end from the opening of the body 11, 21. Said length Ltot of each injector 1, 2 is the distance, in particular along the respective longitudinal axis X, X′, from the first axial end 19′ to the second axial end 19″.

The actuation means 14, 24 are preferably connected to the body 11, 21 by means of a connection body 13, 23, extending between the body 11, 21 and the actuation means 14, 24.

In this case, said length Ltot of each injector 1, 2 comprises the length Lcm of said body 11, 21, the length Lmb (along the longitudinal axis X, X′) of the connection body 13, 23 and the length Lhc of said actuation means 14, 24.

A valve 15, 25, in particular a proportional valve, can be connected to the actuation means 14, 24.

Said length of each injector 1, 2 preferably does not comprise the length of the valve 15, 25.

Preferably, but not exclusively, the two injectors 1, 2 are parallel to each other; in particular, the longitudinal axes thereof are parallel to each other. Alternatively, the two injectors 1, 2 can be transversal to, or aligned with each other.

In particular, the two injectors 1, 2, have the same length Ltot.

The two injectors 1, 2 are preferably equal to each other.

Preferably, the length Ltot of each injector 1, 2 is from 2500 mm to 3300 mm; and/or the length Lcm of each body 11, 21 is from 700 mm to 1200 mm; and/or the length Lhc of the actuation means 14, 24 is from 800 mm to 1300 mm; and/or the length Lmb of the connection body 13, 23 is from 600 mm to 1100 mm.

Preferably, but not exclusively, the injection apparatus 100 has one or more (also combined) of the following features:
the length of the conduit 3 is at least 1.5 times smaller, preferably from 1.6 to 2.2 times smaller than said length Ltot; and/or
the length of the conduit 3 is less than the length Lcm of the body 11, 21 along the longitudinal axis X, X′ of the injector 1, 2; and/or
the inner volume of the conduit 3 is less, preferably equal to half or less, than the maximum inner volume which can receive the molten plastic of each injector 1, 2;
where, in particular, the inner volume of the conduit 3 is the whole volume which can receive the molten plastic, and the maximum inner volume of an injector 1, 2 is the volume delimited by the body 11, 12 and by the piston 12, 22 when the piston 12, 22 is in the completely retracted position (i.e. distal from the opening of the injector 1, 2); and/or
the ratio between the length and the inner diameter of said conduit 3 is from 25 to 50; in particular, the inner diameter can be constant along the conduit 3, or variable and in this latter case, the average inner diameter is considered for the aforesaid length/inner diameter ratio; and/or
the end portion 39 of the conduit 3 adapted to be connected to the plasticization apparatus 102, in particular to the inlet opening 30, is arranged in the space between the orthogonal projections P, Q of the axial ends 19′, 19″ (FIG. 3) of each injector 1, 2 on a horizontal plane H, parallel to the support plane of the injection apparatus 100; and/or
the end portion 39 (more specifically, the inlet opening 30) is at a distance (along the horizontal plane H) from said orthogonal projection P of the end 19′, which is less than Ltot×cos α, where α is the angle formed by the longitudinal axes X, X′ with the horizontal plane H; preferably, said distance is less than Lcm×cos α.

Each of the aforesaid features allows obtaining an improved optimization, in particular a greater reduction, of the volume which the molten plastic must cross to reach the injectors 1, 2.

In any case (in all embodiments), the inner diameter of the conduit 3 is preferably from 30 mm to 50 mm. In particular, the inner diameter of the conduit 3 is selected in this range so as to reduce to a minimum the undesired effects on the molten plastic, including the formation of undesired substances, e.g., due to excessive sheer stress.

The end portion 39 of the conduit 3, in particular the inlet opening 30 adapted to be connected to the plasticization apparatus 102, is preferably arranged in the space below, in particular below and at, or above, in particular above and at, the two injectors 1, 2.

Said end portion 39 preferably comprises a flange for connection to the plasticization apparatus 102.

The injection apparatus 100 is configured so that the two injectors 1, 2 can receive the molten plastic and inject it into the mold in alternate manner.

In particular, the apparatus 100 is configured so that while one of the injectors 1 receives the molten plastic (i.e., it is filled), the other injector 2 injects the molten plastic (and is therefore emptied).

In particular, the apparatus 100 comprises one or more valves 41, 42 (preferably spool valves) to allow the loading with molten plastic of one of the injectors 1 and the injection of the molten plastic exiting another injector 2, in an alternate manner.

Preferably, the injection apparatus 100 comprises two valves 41, 42, in particular one valve 41, 42 for each injector 1, 2.

The conduit 3, preferably extends from the inlet opening 30 for the molten plastic to said two valves 41, 42.

The two branches 32, 33 of the conduit 3 are preferably connected, in particular fixed to a respective valve 41, 42, in particular to the body 411, 421 of a respective valve 41, 42.

Each valve 41, 42 is adapted to allow or prevent the inlet of molten plastic in the respective injector 1, 2, as a function of the position or configuration thereof.

More in detail, each valve 41, 42, in a first position, allows the passage of molten plastic from the conduit 3 to the respective injector 1, 2 (loading step) and prevents the passage of molten plastic from the respective injector 1,2 towards the mold; and in a second position, it allows the passage of molten plastic from the respective injector 1, 2 towards the mold (injection step) and prevents the passage of molten plastic from the conduit 3 to the respective injector 1, 2.

With particular reference to FIG. 6, in particular, the injection apparatus 100 is configured so that the molten plastic coming from the plasticization apparatus 102 is introduced into the conduit 3, in particular into the first stretch 31 and then into the branches 32, 33. In alternate manner, a valve 42 allows the passage of molten plastic from the conduit 3 to the injector 2, and prevents the passage of molten plastic from the respective injector 2 towards the mold; while the other valve 41 allows the passage of molten plastic from the injector 1 towards the mold and prevents the passage of molten plastic from the conduit 3 to the injector 1.

In particular, the apparatus 100 is configured so that while one of the two valves 41, 42 is in the first position, the other valve 41, 42 is in the second position.

In particular, the injection apparatus 100 is configured to control the valve 41 and the valve 42 so that while the valve 41 is in the first position thereof, the valve 42 is in the second position thereof, and vice versa. Indeed, the injection apparatus 100 is configured to cause the valve 41 to pass from the first position to the second position, and vice versa; and to cause the valve 42 to pass from the first position to the second position, and vice versa.

FIG. 6 shows, by way of non-limiting example, a moment in which the injector 2 is about to start the loading step and the injector 1 has completed the injection step.

Each valve 41, 42 is preferably a two-position valve.

Each valve 41, 42 is preferably a three-way valve, in particular a three-way two-position valve.

The valves 41, 42 are preferably configured so that each of them can receive (more specifically, cause to pass therethrough) a volume of molten plastic which is less, in particular much less, than the volume which can be received in the conduit 3.

As an alternative to the two valves 41, 42, only one valve can be provided, capable of allowing the loading of an injector and the injection of the other injector and vice versa.

In variants, which are not shown, the number of valves to control the flow of molten plastic towards the injectors 1, 2 can be greater than two, e.g., three.

In order to actuate each valve 41, 42, in particular, to cause each valve 41, 42 to pass from the first position to the second position and vice versa, actuation means 413, 423 are provided (FIG. 1) for each valve 41, 42. For example, there is provided a respective actuation cylinder for each valve 41, 42.

Preferably, the body 411, 421 of each valve 41, 42 is fixed to the respective injector 1, 2. In particular, the body 411, 421 of each valve 41, 42 is fixed to the end portion of the respective injector 1, 2 where the opening for the inlet and the outlet of molten plastic of the respective injector 1, 2, in particular from the body 11, 21, is present.

Inside the body 411, 421 of the valve 41, 42 there is a movable element 412, 422. The movable element 412, 422 preferably defines a conduit, which, in a position of the valve 41, 42, can communicate (fluidically) with the conduit 3 and with the opening of the injector 1, 2. The movable element 412, 422 also defines a conduit, which, in another position of the valve 41, 42, can communicate (fluidically) with the opening of the injector 1, 2 and with the tubing 5, in particular, with a respective branch 51, 52 of the tubing 5.

Each of the aforesaid actuation means 413, 423 is adapted to move a respective movable element 412, 422.

As said previously, the apparatus 100 further comprises a tubing 5 or channel (FIG. 6), which serves to conduct the molten plastic injected by the injectors 1, 2 towards the mold, in particular, towards the same mold or into the same mold.

The tubing 5 comprises a stretch 50 adapted to receive the molten plastic from the injectors 1, 2. In particular, the stretch 50 can receive both the molten plastic injected by the injector 1, and the molten plastic injected by the injector 2.

The tubing 5 further comprises two branches 51, 52 (or more generally, one branch for each injector), or stretches. Each branch 51, 52 is adapted to receive the molten plastic from a respective injector 1, 2; i.e., each stretch 51, 52 is adapted to receive a respective flow of molten plastic from a respective injector 1, 2. In particular, each branch 51, 52 is connected to the outlet of a respective valve 41, 42.

Stretch 50 is connected to the two branches 51, 52. In particular, the two branches 51, 52 converge in stretch 50, i.e., the flow of molten plastic exiting each branch 51, 52, is introduced into stretch 50. In particular, stretch 50 is fluidically downstream of the branches 51, 52.

A valve 6 is preferably provided along said stretch 50 of the tubing 5.

Preferably, stretch 50 comprises a first stretch 53 and a second stretch 54 (or sub-stretches), both connected to the valve 6. In particular, stretch 53 is upstream of the valve 6 and stretch 54 is downstream of the valve 6. Stretch 54 is substantially a nozzle.

The valve 6, in particular, as a function of the position thereof, is adapted to allow or prevent the passage of molten plastic towards the mold.

The valve 6, in a first position, allows the passage of molten plastic towards the mold, and in a second position, allows the molten plastic to exit the stretch 50 (preventing the molten plastic from reaching the mold), in particular for carrying out an operation of purging.

The valve 6 is preferably a two-way valve, in particular a two-way two-position valve. Actuation means 61, e.g., an actuation cylinder, are provided for actuating the valve 6.

In particular, the valve 6 is only used in the purging step. The purging step is, in particular, the step of starting the molding apparatus 101 (which comprises the injection apparatus 100 and the plasticization apparatus 102). In practice, instead of injecting the first loads of molten PET of each injector 1, 2 directly into the mold, it is preferable to discard such material into a collection tray (not shown), which, in particular, is outside the tubing 5. This is because the first material is highly degraded having spent a long period inside the plasticization apparatus 102 during the heating step, before starting full operation. Injecting it into the mold would result in filling the same with highly degraded material, which is then also difficult to remove.

The injection apparatus 100 preferably comprises a body 8 to which the tubing 5 is connected, in particular to stretch 50, more specifically to stretch 54. The body 8 is configured to be connected to the mold.

Two cylinders, preferably two hydraulic cylinders 71, 72 are preferably provided to allow operations of maintenance and special cleaning, e.g., the removal of stretch 54 (or nozzle). The hydraulic cylinders 71, 72 allow the injectors 1, 2 to retreat, i.e., they allow moving them so as to distance them from the mold and they allow the injectors 1, 2 to advance, i.e., they allow moving them towards the mold.

In particular, the two hydraulic cylinders 71, 72 comprise a respective part 711, 721 adapted to push against the body 8. During normal operation (i.e., full operation) after moving the injection apparatus 100 forward towards the mold in the working position, the two hydraulic cylinders 71, 72 perform the function of keeping the injection apparatus 100 in contact with the mold as they are adapted to exert a sufficient force to contrast the separation force given by the injection pressure, which would tend to separate the nozzle 54 from the mold.

The conduit 3 (in particular stretch 311) is delimited by two parts 91, 92, adapted to slide with respect to each other so as to form a telescopic system. In particular, part 91 is preferably inserted into part 92. Part 91 delimits the inlet opening 30 of the conduit 3, and is adapted to be fixed, in particular, rigidly fixed, to the plasticization apparatus 102. During the aforesaid retreating and advancing of the injectors 1, 2, the part 92 can slide with respect to the part 91. In particular, the sliding can occur along an axis substantially horizontal, or in any case parallel to the support plane of the injection apparatus 100. The injection apparatus 100 is preferably configured so that the variation in length of the conduit 3 due to the aforesaid optional telescopic system is, at most, 150 mm or 100 mm. When the telescopic system is provided, the aforesaid length of the conduit 3 preferably refers to the maximum length when the injectors 1, 2 are in the proximal position with respect to the mold (the distal position is when they are translated into the furthest position from the mold by means of the hydraulic cylinders 71, 72—the position in which the conduit 3 is in the maximum extension thereof).

The telescopic system is particularly advantageous when the plasticization apparatus 102 is of the type that must be fixed, in particular, rigidly, to the ground (or in any case to the support plane of the injection apparatus 100), i.e., it is fixed in position. In fact, it allows horizontally translating the injectors 1, 2 and the components rigidly fixed to the injectors 1, 2, including the valves 41, 42, the tubing 5, and the conduit 3, except for part 91 (part 91 is in fact rigidly fixed to the plasticization apparatus 102, which is preferably fixed in position).

Preferably, but not exclusively, the two injectors 1, 2 are inclined, preferably by an angle α from 10° to 45°, with respect to a horizontal plane H, parallel to the support plane of the injection apparatus 100.

In particular, the two injectors 1, 2 are preferably inclined so that the end portion 19′, where there is provided the opening for the inlet and outlet of molten plastic by the injector 1, 2 (in particular, from the body 11, 21), is further down (i.e., closer to the support plane of the injection apparatus 100) with respect to the end portion 19″, which is axially opposite to the end portion 19′.

One of the advantages associated with the tilting of the injectors 1, 2 consists of optimizing the volumes. In fact, in this way, it is possible to reduce the horizontal volume of the injection apparatus 100, and it is further possible to arrange at least part of the plasticization apparatus 102 in the space below the injectors 1, 2. The tilting of the injectors 1, 2 allows reducing the length of the conduit 3 and therefore, it allows reducing the stay time of the molten plastic inside the conduit 3.

The feature related to the tilting of the injectors 1, 2 is thus preferably, but not exclusively, associated with the arrangement of the end portion 39 of the conduit 3 in the space below the injectors 1, 2.

The injection apparatus 100 preferably comprises a support structure 7, adapted to support, in particular, the injectors 1, 2. The injectors 1, 2 are preferably constrained to the support structure 7 so as to slide with respect thereto. To this end, for example, two sliding guides 73, 74 are provided.

The injection apparatus 100 is particularly adapted to be connected and operate with a plasticization apparatus 102 configured to plasticize PET in the form of flakes. In particular, the plasticization apparatus 102 is preferably configured to generate a substantially continuous flow of molten plastic.

The plasticization apparatus 102 comprises an extruder. In particular, the extruder is configured to generate a substantially continuous flow of molten plastic. Preferably, to this end, the screw of the extruder rotates about the longitudinal axis thereof, preferably at a substantially constant speed, and does not make movements along the longitudinal axis thereof. The plasticization apparatus 102 can comprise other components downstream of the extruder.

The conduit 3, in particular, the inlet opening 30 of the conduit 3, is connected to the last component of the plasticization apparatus 102. Preferably, in all embodiments, the conduit 3 is the only conduit adapted to conduct the molten plastic from the plasticization apparatus 102 towards the two injectors 1, 2, i.e., between the plasticization apparatus 102 and the conduit 3 other conduits are not provided.

By way of non-limiting example, in a plasticization apparatus 102, downstream of the extruder, in particular, a pump can be provided for the molten plastic. Preferably, a filter is provided upstream of the pump and optionally a viscometer, and a purging valve can be provided downstream of the pump. One or more reactors can also be provided upstream of the extruder, for treating, in particular for pretreating, the PET flakes.

Preferably, as anticipated previously, the plasticization apparatus 102 is fixed in position, in particular, it is rigidly fixed to the ground. In fact, the plasticization apparatus 102 can have a weight and volume, which is such as to have to be fixed to the ground, e.g., due to the aforesaid reactors.

The invention also relates to a molding apparatus 101 for producing one or more hollow articles, comprising an injection apparatus 100 and a plasticization apparatus 102 connected to the conduit 3, so that the molten plastic can pass from the plasticization apparatus 102 to the two injectors 1, 2 passing through said conduit 3.

1. An injection apparatus for injecting molten plastic into a mold for molding one or more hollow articles, in particular bottle preforms;
the injection apparatus comprising
two injectors, each defining a respective longitudinal axis, adapted to receive the molten plastic and inject it alternately into the mold;
and a conduit, having an inlet opening for the molten plastic, adapted to be connected to a plasticization apparatus and to conduct the molten plastic from the plasticization apparatus towards the two injectors;
wherein the length of said conduit is less than the length of each of the two injectors along the respective longitudinal axis;
wherein the two injectors are inclined with respect to a horizontal plane, parallel to the support plane of the injection apparatus.

2. The injection apparatus according to claim 1, comprising one or more valves to allow the loading with molten plastic of one of the injectors and the injection of the molten plastic exiting another injector, alternately.

3. The injection apparatus according to claim 2, wherein said conduit extends from the inlet opening for the molten plastic to said one or more valves; preferably, wherein the body of each valve is fixed to the respective injector.

4. The injection apparatus according to claim 1, comprising two valves, of which one valve for each injector; wherein each valve is adapted to allow or prevent the inlet of molten plastic in the respective injector, as a function of the position thereof; preferably, wherein each valve is a three-way valve.

5. The injection apparatus according to claim 4, wherein each valve is adapted to take a first position, in which it allows the passage of molten plastic from the conduit to the respective injector and prevents the passage of molten plastic from the respective injector towards the mold; and a second position, in which it allows the passage of molten plastic from the respective injector towards the mold and prevents the passage of molten plastic from the conduit to the respective injector.

6. The injection apparatus according to claim 1, wherein the two injectors are inclined by an angle from 10° to 45° with respect to said horizontal plane, parallel to the support plane of the injection apparatus.

7. The injection apparatus according to claim 1, wherein each of the injectors comprises a body adapted to receive the molten plastic, a piston adapted to slide in the body, and actuation means adapted to move the piston;
wherein the length of the conduit is smaller than the length (Lcm) of each body; and/or
wherein said length of each injector comprises the length of said body and the length of said actuation means.

8. The injection apparatus according to claim 7, wherein each injector has a first axial end and a second axial end;
wherein the first axial end delimits the opening of said body through which the molten plastic can pass, in particular for entering and exiting the body;
and wherein said length of each injector is the distance from the first axial end to the second axial end; preferably, wherein the second axial end is an end of said actuation means.

9. The injection apparatus according to claim 1, wherein the inner volume of said conduit is less, preferably equal to half or less, with respect to the maximum inner volume, which can receive the molten plastic, of each injector.

10. The injection apparatus according to claim 1, wherein the ratio between the length and the inner diameter of said conduit is from 25 to 50.

11. The injection apparatus according to claim 1, wherein said conduit has two outlet openings;
and wherein said length of the conduit is measured from the inlet opening to the two outlet openings; in particular wherein said length of the conduit corresponds to the length of the path covered by the molten plastic when it crosses the conduit from the inlet opening to the two outlet openings.

12. The injection apparatus according to claim 1, wherein the conduit comprises a first stretch, provided with said inlet opening; and two branches, each branch being adapted to carry the molten plastic towards a respective injector; in particular wherein each branch is provided with a respective outlet opening of the conduit; preferably wherein each branch is connected to a respective valve.

13. The injection apparatus according to claim 12, wherein part of said conduit is delimited by a T-shaped or a Y-shaped component, which comprises said two branches; and/or wherein said first stretch of the conduit comprises two stretches, which are transversal to each other.

14. An injection apparatus (100) according to claim 12 or 13, wherein said first stretch (31) of the conduit (3) comprises two stretches (311, 312), which are transversal to each other.

15. The injection apparatus according to claim 1, wherein the inlet opening of the conduit adapted to be connected to the plasticization apparatus is arranged in the space between the orthogonal projections of the axial ends of each injector on a horizontal plane, parallel to the support plane of the injection apparatus.

16. The injection apparatus according to claim 1, wherein the inlet opening of the conduit adapted to be connected to the plasticization apparatus is arranged in the space below, in particular below and at, or above, in particular above and at, the two injectors.

17. The injection apparatus according to claim 1, comprising a tubing for carrying the molten plastic from the injectors towards the mold;
wherein said tubing comprises a stretch adapted to receive the molten plastic from the injectors.

18. The injection apparatus according to claim 17, wherein along said stretch of the tubing there is provided a valve, which, in a first position, allows the passage of molten plastic towards the mold, and in a second position, allows the exit of the molten plastic from the stretch, in particular for carrying out an operation of purging.

19. The injection apparatus according to claim 1, wherein the conduit is delimited by two parts adapted to slide with respect to each other, in particular so as to form a telescopic system; wherein a first part of said two parts delimits said inlet opening of the conduit, is adapted to be fixed to the plasticization apparatus, and is preferably inserted into the second part of said two parts.

20. A molding apparatus for producing one or more hollow articles, comprising an injection apparatus according to claim 1, and a plasticization apparatus connected to the conduit, so that the molten plastic can pass from the plasticization apparatus to the two injectors.

21. The molding apparatus according to claim 20, wherein said plasticization apparatus is arranged, at least partially, in the space below the two injectors.
